(19) United States
(12) Patent Application Publication
(10) Pub. No.: US 2026/0273710 A1
(43) Pub. Date: Sep. 17, 2026

(54) WORKING MACHINE

(71) Applicant: KOKI HOLDINGS CO., LTD., Tokyo (JP)

(72) Inventors: Shogo Kurokawa, Ibaraki (JP); Masashi Nishida, Ibaraki (JP)

(21) Appl. No.: 18/877,885

(22) PCT Filed: Jun. 23, 2023
(86) PCT No.: PCT/JP2023/023399

§ 371 Date: Dec. 20, 2024

(30) Foreign Application Priority Data
Jun. 29, 2022 (JP) 2022-104747

(51) Int. Cl. B25C 1/04; B25C 1/06

(52) U.S. Cl. CPC B25C 1/047; B25C 1/06

(57) ABSTRACT

To maintain driving force over a long period of time in a working machine. A fastener driving machine includes a tubular cylinder, an accumulator container closing an upper end portion of the cylinder in an up-down direction, a piston unit defining a pressure chamber in cooperation with the cylinder and the accumulator container and applying striking force to a fastener, and a nut partitioning an internal space of the cylinder and an internal space of the accumulator container from each other. Grease is applied to an inner wall of the cylinder, and the nut has a through-hole communicating with the internal space of the cylinder and the internal space of the accumulator container and directing a passing air flow toward the inner wall of the cylinder.

### TECHNICAL FIELD

The present invention relates to a working machine such as a fastener driving machine.

### BACKGROUND ART

As one example of a working machine, there has been known a fastener driving machine having a tubular cylinder and a piston that reciprocates in the cylinder.

As the fastener driving machine described above, for example, Patent Literature 1 discloses a fastener driving machine including a tubular cylinder, a piston that reciprocates in the cylinder, and an accumulator provided above the cylinder and communicating with the cylinder.

### CITATION LIST

### Patent Literature

Patent Literature 1: JP-A-2018-1336

### SUMMARY OF INVENTION

### Technical Problem

In the fastener driving machine described in Patent Literature 1 above, grease (lubricant) is applied to an inner wall of the cylinder so that the piston smoothly moves on the cylinder.

However, due to the reciprocation of the piston, the grease may be scraped out of the area of the reciprocation of the piston, and may be accumulated on an upper portion of the piston. When the grease is accumulated on the upper portion of the piston, such grease interferes with smooth movement of the piston, and sliding resistance during the reciprocation of the piston increases. As a result, there is a possibility that the driving force of the fastener driving machine is reduced.

An object of the present invention is to provide a working machine capable of maintaining driving force over a long period of time.

### Solution to Problem

A working machine of the present invention includes a tubular cylinder extending in a first direction, an accumulator container closing a one-side end portion of the cylinder in the first direction and communicating with the inside of the cylinder, a piston unit provided movably in the first direction in the cylinder, defining a pressure chamber in cooperation with the cylinder and the accumulator container, and moving to the other side in the first direction by pressure of gas in the pressure chamber to apply striking force to a fastener, and a partition partitioning the internal space of the cylinder and the internal space of the accumulator container from each other, in which lubricant is applied to an inner wall of the cylinder, and the partition has a through-hole communicating with the internal space of the cylinder and the internal space of the accumulator container and directing a passing air flow toward the inner wall of the cylinder.

### Advantageous Effects of Invention

According to the present invention, in the working machine the driving force can be maintained over a long period of time.

### BRIEF DESCRIPTION OF DRAWINGS

FIG. 1 is a side sectional view showing an internal structure of a working machine according to an embodiment of the present invention.

FIG. 2 is a sectional view showing the location of a piston at a top dead center and a bottom dead center in the working machine in FIG. 1.

FIG. 3 is a plan view showing the structure of the working machine of FIG. 2 as viewed from above with an accumulator container removed.

FIG. 4(a) and 4(b) are views showing the structure of a partition (nut) assembled with the working machine of FIG. 2, where FIG. 4(a) is a plan view and FIG. 4(b) is a side view.

FIG. 5(a) and 5(b) are views showing the structure of the partition of FIG. 4, where FIG. 5(a) is a bottom view and FIG. 5(b) is a sectional view taken along line A-A in FIG. 4(a).

FIG. 6 is a sectional view showing the flow of air passing through a through-hole of the partition when the piston is pressurized in the working machine of FIG. 2.

FIG. 7 is a sectional view showing a structure at the time of pressurizing a piston in a working machine according to a first modification of the present invention.

FIG. 8 is a plan view showing the structure of the working machine of FIG. 7 as viewed from above with an accumulator container removed.

FIG. 9 is a sectional view showing a structure at the time of pressurizing a piston in a working machine according to a second modification of the present invention.

FIG. 10 is a plan view showing the structure of the working machine of FIG. 9 as viewed from above with an accumulator container removed.

FIG. 11 is a sectional view showing a structure at the time of pressurizing a piston in a working machine according to a third modification of the present invention.

FIG. 12 is a plan view showing the structure of the working machine of FIG. 11 as viewed from above with an accumulator container removed.

FIG. 13 is a sectional view showing a structure at the time of pressurizing a piston in a working machine according to a fourth modification of the present invention.

FIG. 14 is a plan view showing the structure of the working machine of FIG. 13 as viewed from above with an accumulator container removed.

### DESCRIPTION OF EMBODIMENTS

Hereinafter, one example of an embodiment of the present invention will be described in detail with reference to the drawings.

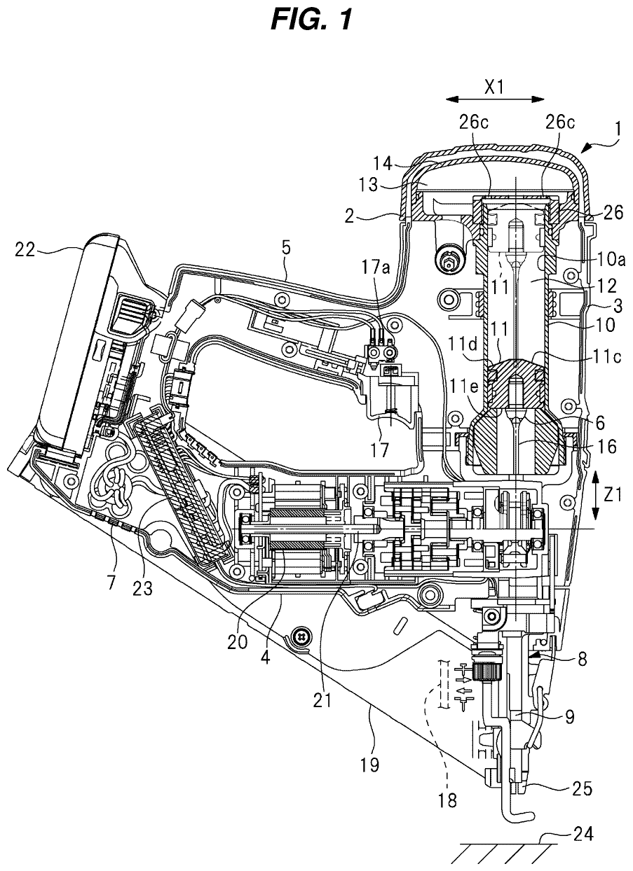

In the present embodiment, a fastener driving machine will be described as one example of the working machine. As shown in FIG. 1, a fastener driving machine 1 has a housing 2. The housing 2 includes a cylinder case 3, a motor case 4, and a handle 5, the cylinder case 3 houses a cylinder 10, and the motor case 4 houses an electric motor 20.

The motor case 4 and the handle 5 extend substantially parallel to each other from the cylinder case 3, and an end portion of the motor case 4 and an end portion of the handle 5 are coupled to each other by a coupling portion 7. The housing 2 has two housing halves made of synthetic resin such as nylon or polycarbonate, and the housing 2 is assembled by butting the two housing halves.

The cylinder 10 has a tubular shape extending in an up-down direction (first direction) Z1, and a piston unit 11 is reciprocally housed in the cylinder 10. The piston unit 11 reciprocates between a top dead center and a bottom dead center along the axial direction (up-down direction Z1) of the cylinder 10 in the cylinder 10. In the cylinder 10, an inner wall 10a (inner peripheral surface) of the cylinder 10 and an upper surface 11c of the piston unit 11 define a piston chamber 12 whose volume increases and decreases as the piston unit 11 reciprocates.

On the other hand, a driver blade 16 is coupled to a lower surface 11e of the piston unit 11. The driver blade 16 is integrated with the piston unit 11, and reciprocates together with the piston unit 11. That is, a striking unit 6 including the piston unit 11 and the driver blade 16 reciprocates in the cylinder 10. Specifically, an injection unit 8 is provided at the end of the cylinder case 3, and an injection passage 9 is provided inside the injection unit 8. The driver blade 16 reciprocates in the injection passage 9 along with reciprocation of the piston unit 11. In the following description, the reciprocation direction of the piston unit 11 and the driver blade 16 in FIG. 1 will be defined as the up-down direction (first direction) Z1.

A magazine 19 housing many fasteners (for example, a nail) 18 is attached to the housing 2. The fasteners 18 housed in the magazine 19 are supplied to the injection passage 9 one by one by a supply mechanism included in the magazine 19. The driver blade 16 strikes head portions of the fasteners 18 sequentially supplied to the injection passage 9. The fastener 18 whose head portion has been struck by the striking unit 6 passes through the injection passage 9 of the injection unit 8, is driven out of an injection port which is an outlet of the injection passage 9, and is driven into an opponent member 24 such as wood or plasterboard.

The motor case 4 houses the electric motor 20, and an output shaft 21 of the electric motor 20 is connected to a wheel to be driven by the electric motor 20 via a planetary gear type speed reduction mechanism. The electric motor 20 is operated by electric power supplied from a battery 22 attached to the coupling portion 7 of the housing 2. A controller 23 as a control unit is housed in the coupling portion 7. The controller 23 is a microcomputer including, e.g., a CPU, a ROM, and a RAM, and controls the electric motor 20. Specifically, the electric motor 20 is a brushless motor, and the controller 23 changes the duty ratio of the motor current supplied to the electric motor 20 according to a control mode. That is, the controller 23 performs pulse width modulation (PWM) control on the electric motor 20.

A damper 15 made of rubber or urethane is provided on the bottom of the cylinder 10. The damper 15 receives the piston unit 11 having reached the bottom dead center, and avoids collision between the piston unit 11 and the cylinder 10. The driver blade 16 extending downward from the piston unit 11 penetrates the damper 15, and protrudes from the cylinder 10 through a through-hole provided in the bottom of the cylinder 10.

An accumulator container 14 forming a pressure chamber 13 is provided above the cylinder 10, and the pressure chamber 13 communicates with the piston chamber 12. The piston chamber 12 and the pressure chamber 13 are filled with high-pressure gas (compressed air in the present embodiment) in advance. When the piston unit 11 at the bottom dead center is moved to the top dead center, the electric motor 20 is operated under the control of the controller 23.

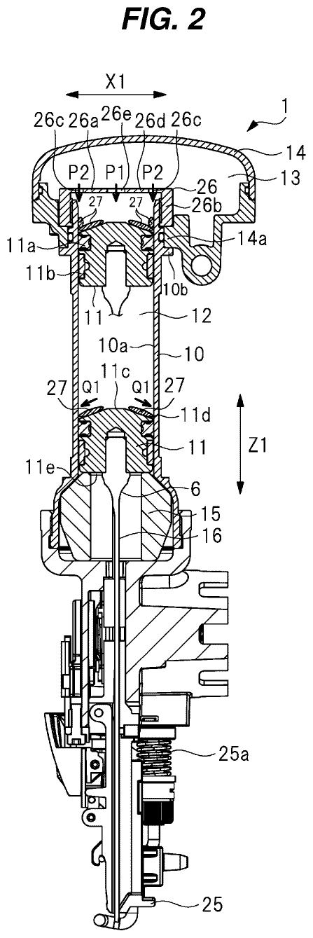

The injection unit 8 is provided with a push lever 25. The push lever 25 is held movably in the up-down direction Z1, and is constantly biased downward by a coiled spring 25a (see FIG. 2 described later). When the push lever 25 is pressed against the opponent member 24 and moves upward against the biasing of the spring 25a, a signal is output. The handle 5 is provided with a trigger unit 17 to be operated by a worker, and when the trigger unit 17 is operated, a trigger switch 17a built in the handle 5 is operated, and a signal for driving operation is output.

When both the signals by the operation of the push lever 25 and the operation of the trigger unit 17 are input, the controller 23 supplies the motor current to the electric motor 20 to operate the electric motor 20. Accordingly, the wheel is rotationally driven, the driver blade 16 is pushed up, and the piston unit 11 moves from the bottom dead center to the top dead center. Thereafter, the piston unit 11 moves from the top dead center to the bottom dead center, and the driver blade 16 moves down. That is, the piston unit 11 reciprocates once between the bottom dead center and the top dead center, and accordingly, the fastener 18 is struck by the driver blade 16 and is driven out. In other words, the driving operation is executed once.

Next, details of the pressure chamber 13 formed in the fastener driving machine 1 of the present embodiment will be described. The fastener driving machine 1 is provided with the accumulator container 14 closing the upper end portion (one-side end portion) of the cylinder 10 in the up-down direction (first direction) Z1 and communicating with the inside of the cylinder 10. In the cylinder 10, the piston unit 11 is further provided so as to move in the up-down direction Z1. The piston unit 11 is a member that applies striking force to the fastener 18 by moving downward (other side) in the up-down direction Z1 by the pressure of gas in the pressure chamber 13. Further, the piston unit 11 defines the pressure chamber 13 in cooperation with the cylinder 10 and the accumulator container 14, and moves downward by being pressed by the compressed air supplied from the pressure chamber 13.

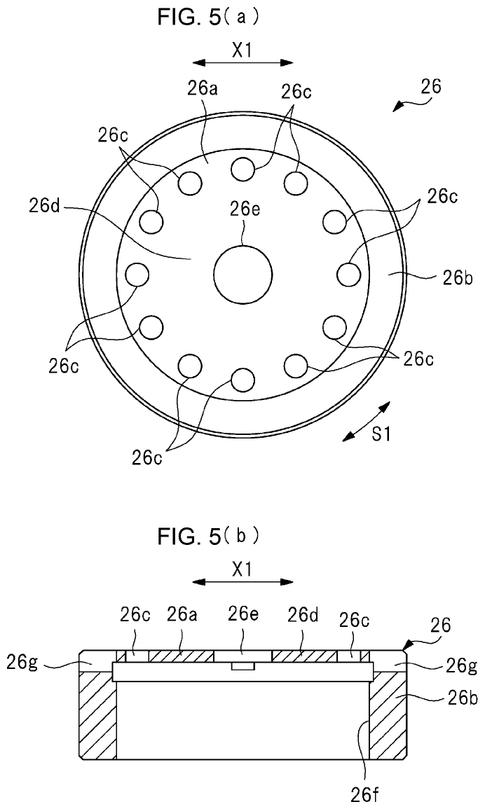

Here, the pressure chamber 13 of the fastener driving machine 1 is provided with a partition partitioning the internal space of the cylinder 10 and the internal space of the accumulator container 14 from each other. The partition is provided in the vicinity of the upper end of the cylinder 10, and in the present embodiment, a case where the partition is a nut 26 will be described. As shown in FIG. 2, the nut 26 includes a disk portion 26a and a tubular portion 26b. The nut 26 is fitted onto an upper end portion of the cylinder 10, and is screwed to an outer peripheral portion of the cylinder 10. Specifically, as shown in FIG. 5, a female screw thread groove is formed in the inner peripheral surface 26f of the tubular portion 26b of the nut 26, and is screwed to a male screw thread formed in the outer peripheral surface of the cylinder 10. At this time, as shown in FIG. 2, a flange (protrusion) 10b is provided on the outer peripheral portion of the cylinder 10, and a connection end portion 14a of the accumulator container 14 is sandwiched and supported by the tubular portion 26b of the nut 26 and the flange 10b of the cylinder 10. That is, the nut 26 fixes the cylinder 10 and the accumulator container 14. That is, by fastening the nut 26 to the outer peripheral surface of the cylinder 10, the accumulator container 14 is sandwiched between the nut 26 and the flange 10b of the cylinder 10.

The pressure chamber 13 is partially defined by the piston unit 11 that reciprocates in the cylinder 10. That is, it is necessary to maintain the airtight state of the piston chamber 12 when the piston unit 11 moves downward in the cylinder 10 by the pressure of gas in the pressure chamber 13. Thus, an X ring 11a is attached to an outer peripheral portion of the piston unit 11. Further, in order to enhance the slidability of the piston unit 11, a slide ring 11b is attached to an outer peripheral portion of the piston unit 11. Thus, when the piston unit 11 moves, the airtight state of the piston chamber 12 can be maintained, and the slidability of the piston unit 11 can also be enhanced.

Note that the piston unit 11 needs to smoothly reciprocate in the cylinder 10, and for this reason, grease (lubricant) 27 is applied to the inner wall 10a of the cylinder 10. However, when the piston unit 11 repeatedly moves up and down by the driving operation, the grease 27 is scraped out by the X ring 11a and the slide ring 11b and is gradually lifted up to an upper portion of the inner wall 10a of the cylinder 10 because the X ring 11a and the slide ring 11b are in close contact with the inner wall 10a of the cylinder 10. As a result, the grease 27 is accumulated in the vicinity of an upper surface 11c of the piston unit 11 or in the vicinity of the upper end of the inner wall 10a of the cylinder 10. When the driving operation by the piston unit 11 is continued in this state, for example, the piston unit 11 moves up and down in a state of the grease 27 adhering to the upper surface 11c of the piston unit 11, or the grease 27 adhering to the vicinity of the upper end of the inner wall 10a of the cylinder 10 remains in the vicinity of the upper end of the inner wall 10a of the cylinder 10. As a result, the grease 27 is not supplied to the entirety of the inner wall 10a of the cylinder 10, the sliding resistance of the X ring 11a and the slide ring 11b increases during movement of the piston unit 11, and the driving force of the fastener driving machine 1 gradually decreases.

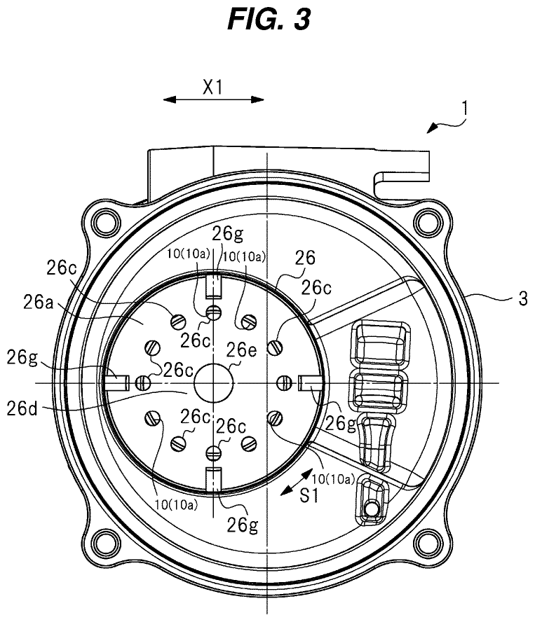

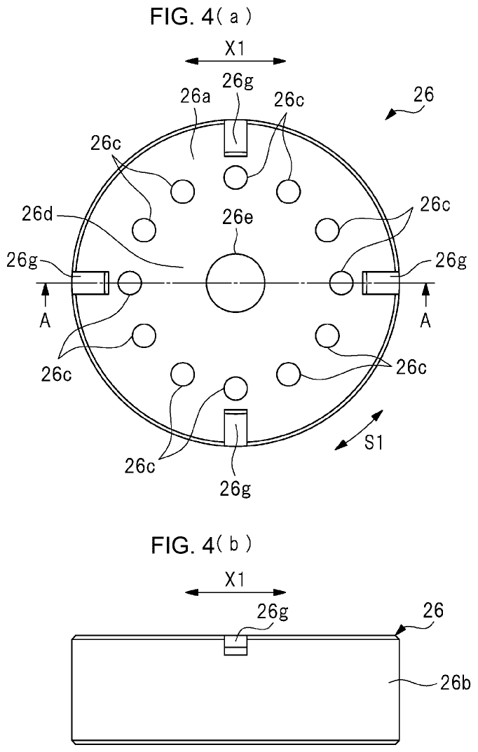

For this reason, in the fastener driving machine 1 of the present embodiment, the nut 26 has a through-hole 26c communicating with the internal space of the cylinder 10 and the internal space of the accumulator container 14 as viewed in the up-down direction Z1. Specifically, as shown in FIG. 3, a plurality of through-holes 26c is provided in the disk portion 26a of the nut 26. As shown in FIGS. 4 and 5, the nut 26 includes the disk portion 26a and the tubular portion 26b, and a thread groove to be screwed to the cylinder 10 is formed in the inner peripheral surface 26f of the tubular portion 26b. Cutouts 26g are formed at four locations in an outer peripheral portion of the disk portion 26a, and the nut 26 is turned with, e.g., a jig fitted in the cutouts 26g and is attached or detached accordingly.

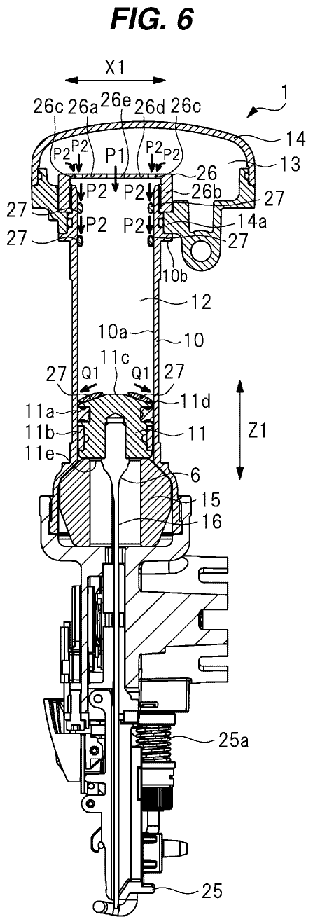

The disk portion 26a of the nut 26 is provided with the plurality of through-holes 26c as described above, and is further provided with a through-hole 26e in the vicinity of the center of the disk portion 26a. Similarly to each of the plurality of through-holes 26c, the through-hole 26e also communicates with the internal space of the cylinder 10 and the internal space of the accumulator container 14. Thus, as shown in FIG. 2, during the driving operation by the piston unit 11, compressed air P1, P2 supplied from the pressure chamber 13 is supplied into the cylinder 10 through the through-holes 26c, 26e. At this time, in the fastener driving machine 1, particularly the grease 27 adhered to the upper surface 11c of the piston unit 11 and the grease 27 adhered to the vicinity of the upper end of the inner wall 10a of the cylinder 10 shown in FIG. 6 can be spread over an area where the piston unit 11 slides on the inner wall 10a of the cylinder 10 by the pressure of the compressed air P2 passing through the plurality of through-holes 26c. That is, the plurality of through-holes 26c is configured to direct the compressed air P2 passing therethrough toward the inner wall 10a of the cylinder 10, and the compressed air P2 passing through the plurality of through-holes 26c is vigorously discharged toward the inner wall 10a of the cylinder 10. Thus, the grease 27 accumulated on the upper portion of the cylinder 10 is pushed downward by the pressure of the compressed air P2, and as a result, the grease 27 is moved down to the area where the piston unit 11 slides and the piston unit 11 can move smoothly. Consequently, it is possible to reduce the sliding resistance of the X ring 11a and the slide ring 11b during movement of the piston unit 11 and to suppress a decrease in the driving force of the fastener driving machine 1. That is, in the fastener driving machine 1, the driving force can be maintained over a long period of time.

As shown in FIG. 2, the piston unit 11 of the fastener driving machine 1 is provided, at the upper surface 11c thereof, with an inclined surface 11d inclined outward in the radial direction X1 of the cylinder 10. Since the inclined surface 11d is provided at the upper surface 11c of the piston unit 11, when the piston unit 11 moves down and comes into contact with the damper 15 during the driving operation, the grease 27 accumulated on the upper surface 11c of the piston unit 11 moves in a direction Q1 toward the outer periphery along the inclined surface 11d by inertial force, and is scattered to the inner wall 10a of the cylinder 10. Accordingly, the grease 27 adheres to the area where the piston unit 11 slides on the inner wall 10a of the cylinder 10, and the piston unit 11 can move smoothly.

The plurality of through-holes 26c provided in the disk portion 26a of the nut 26 is preferably provided along the inner wall 10a of the cylinder 10 in order to press the grease 27 by the compressed air P2 passing through the plurality of through-holes 26c and push down the grease 27 along the inner wall 10a of the cylinder 10. The opening shape of the through-hole 26c is, for example, a circular shape. As shown in FIG. 3, each of the plurality of through-holes 26c is preferably provided at a location overlapping with the inner wall 10a of the cylinder 10 as viewed in the up-down direction Z1. That is, each through-hole 26c is preferably provided to such an extent that part of the inner wall 10a of the cylinder 10 is visible from above in each through-hole 26c. Since each through-hole 26c is provided to such an extent that part of the inner wall 10a of the cylinder 10 is visible from above in each through-hole 26c, the pressure of the compressed air P2 passing through each through-hole 26c can be efficiently applied to the grease 27. As a result, the grease 27 can moderately adhere to the area where the piston unit 11 slides on the inner wall 10a of the cylinder 10, and the piston unit 11 can move more smoothly.

As shown in FIG. 4, the nut 26 has, in the disk portion 26a thereof, a wall portion 26d located inside the through-holes 26c in the radial direction X1 of the cylinder 10. That is, in the disk portion 26a, the wall portion 26d is at a location (location close to the center) inside the plurality of through-holes 26c provided along the inner wall 10a of the cylinder 10, and the circular through-hole 26e larger than the through-hole 26c is provided at the center of the wall portion 26d. In other words, the through-hole 26e is provided at the center of the disk portion 26a, the wall portion 26d is provided outside the through-hole 26e, and further, the plurality of through-holes 26c is formed outside the wall portion 26d. Thus, the compressed air P2 having contacted the wall portion 26d can be appropriately dispersed so as to flow to the plurality of through-holes 26c. That is, the compressed air P2 is brought into contact with the wall portion 26d to flow to the plurality of through-holes 26c in a dispersed manner, and as a result, the grease 27 can appropriately adhere to the area where the piston unit 11 slides on the inner wall 10a of the cylinder 10, and the piston unit 11 can move smoothly.

In the fastener driving machine 1, the accumulator container 14 is fixed to the cylinder 10 by the nut 26. Thus, it is possible to facilitate maintenance and component replacement for the pressure chamber 13 and to reduce component costs.

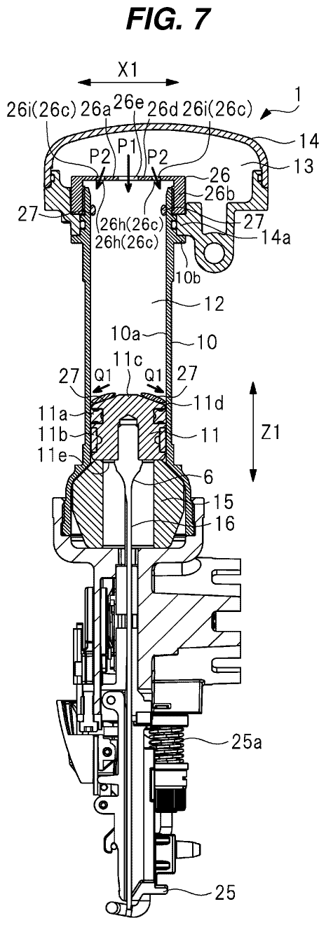

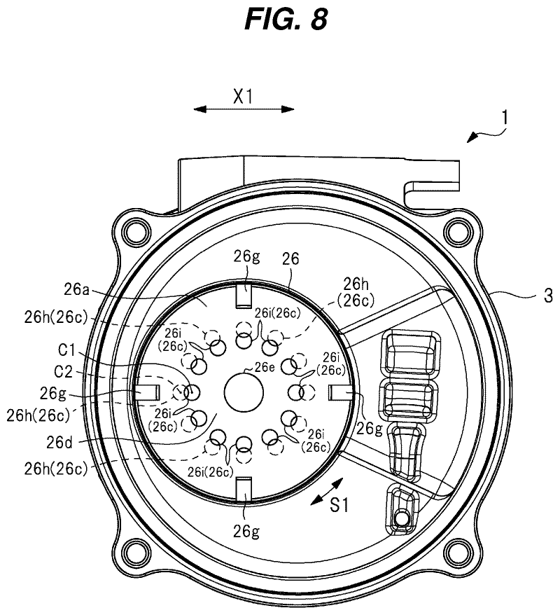

Next, fastener driving machines 1 according to modifications of the present embodiment will be described. In the fastener driving machine 1 of the first modification shown in FIGS. 7 and 8, each of the plurality of through-holes 26c provided in the disk portion 26a is formed obliquely toward the inner wall 10a of the cylinder 10 so as to direct the compressed air P2 having passed through the through-holes 26c toward the inner wall 10a of the cylinder 10. Specifically, each of the plurality of through-holes 26c is provided inside the inner wall 10a of the cylinder 10 in the radial direction X1 of the cylinder 10, and further, a cylinder 10-side opening 26h of the through-hole 26c is located outside an accumulator container 14-side opening 26i of the through-hole 26c in the radial direction X1 of the cylinder 10. For example, the cylinder 10-side opening 26h and the accumulator container 14-side opening 26i of the through-hole 26c are in a circular shape, and a center C1 of the circular opening 26i and a center C2 of the circular opening 26h are shifted from each other. Here, in the radial direction X1 of the cylinder 10, the center C2 of the cylinder 10-side opening 26h is located outside the center C1 of the accumulator container 14-side opening 26i. That is, each through-hole 26c is formed obliquely toward the inner wall 10a of the cylinder 10, and as a result, the compressed air P2 passing through the through-hole 26c can be more strongly blown toward the inner wall 10a of the cylinder 10. Thus, the grease 27 can moderately adhere to the area where the piston unit 11 slides on the inner wall 10a of the cylinder 10, and the piston unit 11 can move smoothly.

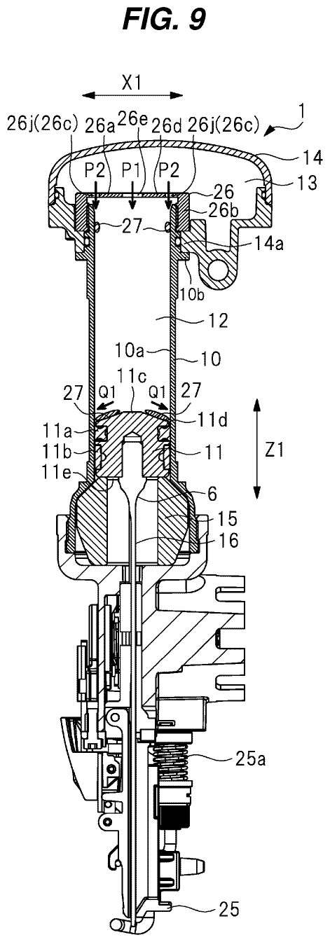

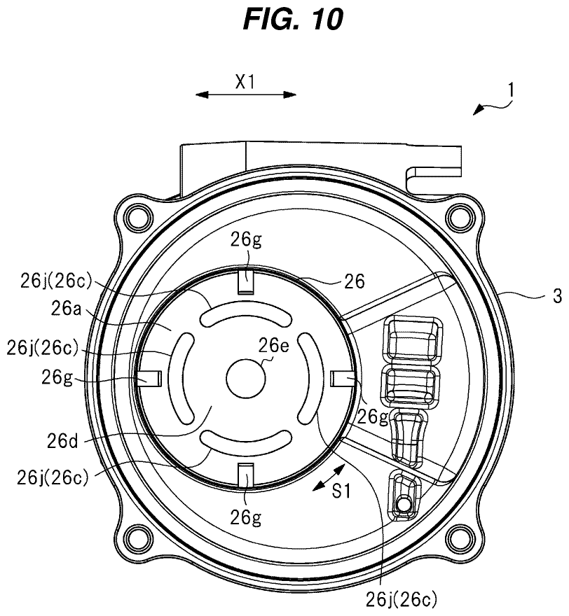

In the fastener driving machine 1 of the second modification shown in FIGS. 9 and 10, the through-hole 26c is a long hole 26j extending in the circumferential direction S1 of the inner wall 10a of the cylinder 10. Thus, the compressed air P2 passing through the long hole 26j is supplied along the inner wall 10a of the cylinder 10, and therefore, the grease 27 can moderately adhere to the area where the piston unit 11 slides on the inner wall 10a of the cylinder 10 and the piston unit 11 can move smoothly.

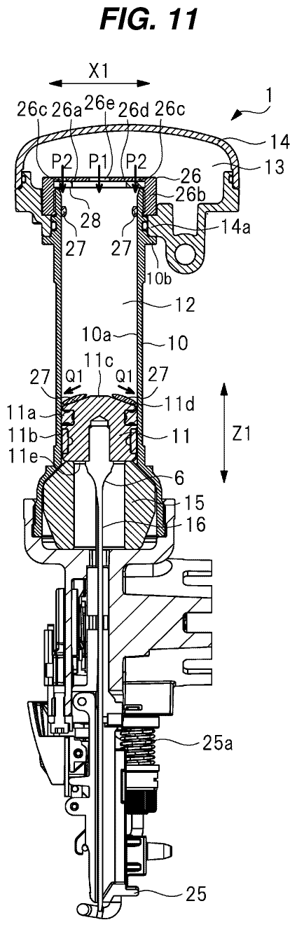

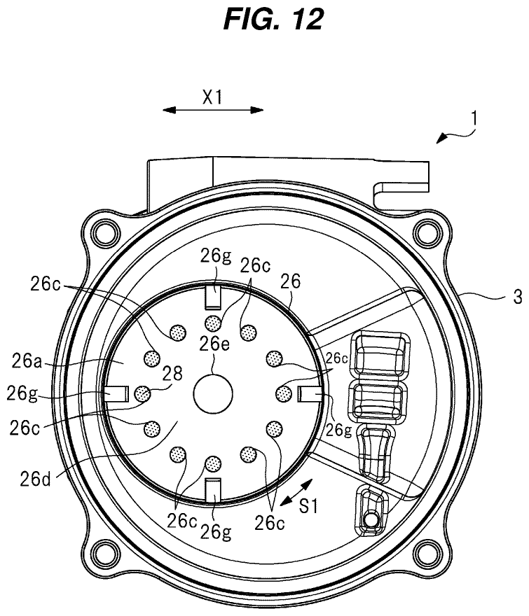

In the fastener driving machine 1 of the third modification shown in FIGS. 11 and 12, a felt member 28 is disposed at an upper end portion of the cylinder 10. The felt member 28 has, for example, a ring shape, and is sandwiched and fixed between the nut 26 and the end portion of the cylinder 10. By impregnating the felt member 28 with the grease 27, the grease 27 having permeated the felt member 28 is scattered by the compressed air P2 passing through the through-hole 26c, and the grease 27 can appropriately adhere to the area where the piston unit 11 slides on the inner wall 10a of the cylinder 10. As a result, the piston unit 11 can move smoothly.

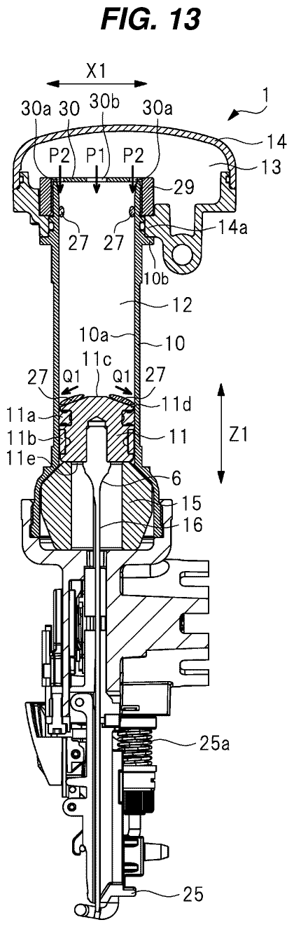

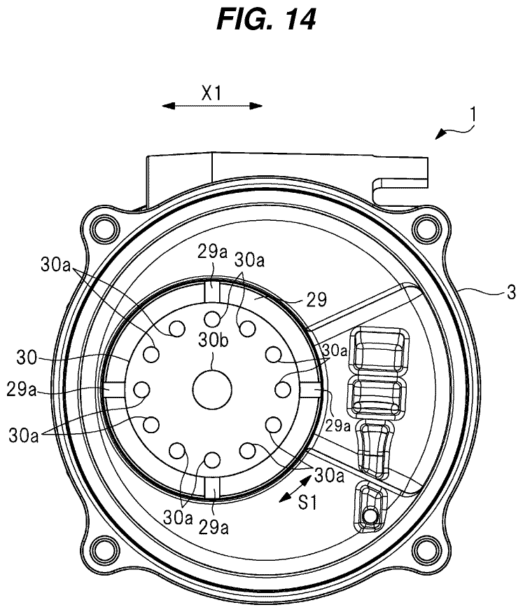

In the fastener driving machine 1 of the fourth modification shown in FIGS. 13 and 14, a nut 29 for fixing the accumulator container 14 and a partition plate 30 as the partition are separated. That is, the nut 29 has a tubular shape, and the circular partition plate 30 fitted in the nut 29 is disposed at an end portion of the inner wall 10a of the cylinder 10. As shown in FIG. 14, the nut 29 is provided with cutouts 29a for fitting, e.g., a jig. The partition plate 30 is provided with a plurality of through-holes 30a provided along the inner wall 10a of the cylinder 10, and further a circular through-hole 30b larger than the through-hole 30a is provided at a location (location close to the center) inside the plurality of through-holes 30a.

Thus, the compressed air P2 passing through the plurality of through-holes 30a is supplied along the inner wall 10a of the cylinder 10, and therefore, the grease 27 can moderately adhere to the area where the piston unit 11 slides on the inner wall 10a of the cylinder 10 and the piston unit 11 can move smoothly.

The present invention is not limited to the above embodiments, and various changes can be made without departing from the gist of the present invention. For example, not the plurality of through-holes 26c but at least one through-hole 26c may be provided in the disk portion 26a of the nut 26, and the large through-hole 26e is not necessarily provided.

The opening shape of the through-holes 26c, 26e, 30a, 30b is not limited to the circular shape, and may be a polygonal shape such as a quadrangular shape.

### DESCRIPTION OF REFERENCE SIGNS

1 Fastener Driving Machine (Working Machine)
2 Housing
3 Cylinder Case
4 Motor Case
5 Handle
6 Striking Unit
7 Coupling Portion
8 Injection Unit
9 Injection Passage
10 Cylinder
10a Inner Wall
10b Flange (Protrusion)
11 Piston Unit
11a X Ring
11b Slide Ring
11c Upper Surface
11d Inclined Surface
11e Lower Surface
12 Piston Chamber
13 Pressure Chamber
14 Accumulator Container
14a Connection End Portion
15 Damper
16 Driver Blade
17 Trigger Unit
17a Trigger Switch
18 Fastener
19 Magazine
20 Electric Motor
21 Output Shaft
22 Battery
23 Controller
24 Opponent Member
25 Push Lever
25a Spring
26 Nut (Partition)
26a Disk Portion
26b Tubular Portion
26c Through-Hole
26d Wall Portion
26e Through-Hole
26f Inner Peripheral Surface
26g Cutout
26h, 26i Opening
26j Long Hole
27 Grease (Lubricant)
28 Felt Member
29 Nut
29a Cutout
30 Partition Plate (Partition)
30a, 30b Through-Hole
C1, C2 Center
P1, P2 Compressed Air
Q1 Direction toward Outer Periphery
S1 Circumferential Direction
X1 Radial Direction
Z1 Up-Down Direction (First Direction)

1-8. (canceled)

9. A working machine comprising:
a tubular cylinder extending in a first direction;
an accumulator container closing a one-side end portion of the cylinder in the first direction and communicating with an inside of the cylinder;
a piston unit provided movably in the first direction in the cylinder, defining a pressure chamber in cooperation with the cylinder and the accumulator container, and moving to the other side in the first direction by pressure of gas in the pressure chamber to apply striking force to a fastener; and
a lubricant supplying part disposed in the accumulator container, positioned in an extension area which is extended in the first direction from cylinder, and configured to supply a lubricant to the piston unit along an inner wall of the cylinder from an inside of the accumulator container.

10. The working machine according to claim 9, further comprising:
a partition partitioning an internal space of the cylinder and an internal space of the accumulator container from each other,
wherein lubricant is applied to an inner wall of the cylinder, and
the partition has a through-hole communicating with the internal space of the cylinder and the internal space of the accumulator container and directing a passing air flow toward the inner wall of the cylinder.

11. A working machine comprising:
a tubular cylinder extending in a first direction;
an accumulator container closing a one-side end portion of the cylinder in the first direction and communicating with an inside of the cylinder;
a piston unit provided movably in the first direction in the cylinder, defining a pressure chamber in cooperation with the cylinder and the accumulator container, and moving to the other side in the first direction by pressure of gas in the pressure chamber to apply striking force to a fastener; and
a partition partitioning an internal space of the cylinder and an internal space of the accumulator container from each other,
wherein lubricant is applied to an inner wall of the cylinder,
the partition has a through-hole communicating with the internal space of the cylinder and the internal space of the accumulator container and directing a passing air flow toward the inner wall of the cylinder,
the through-hole is provided at a location overlapping with the inner wall of the cylinder as viewed in the first direction,
the partition has a wall portion located inside the through-hole in a radial direction of the cylinder.

12. The working machine according to claim 11, wherein a plurality of the through-holes is provided along the inner wall of the cylinder.

13. A working machine comprising:
a tubular cylinder extending in a first direction;
an accumulator container closing a one-side end portion of the cylinder in the first direction and communicating with an inside of the cylinder;
a piston unit provided movably in the first direction in the cylinder, defining a pressure chamber in cooperation with the cylinder and the accumulator container, and moving to the other side in the first direction by pressure of gas in the pressure chamber to apply striking force to a fastener; and
a partition partitioning an internal space of the cylinder and an internal space of the accumulator container from each other,
wherein lubricant is applied to an inner wall of the cylinder,
the partition has a through-hole communicating with the internal space of the cylinder and the internal space of the accumulator container and directing a passing air flow toward the inner wall of the cylinder,
wherein the through-hole is provided inside the inner wall of the cylinder in a radial direction of the cylinder, and
a cylinder-side opening of the through-hole is located outside an accumulator container-side opening of the through-hole in the radial direction of the cylinder.

14. The working machine according to claim 10, wherein the through-hole is a long hole extending in a circumferential direction of the inner wall of the cylinder.

15. The working machine according to claim 10, wherein the partition is a nut fixing the cylinder and the accumulator container.

16. The working machine according to claim 15, wherein a protrusion is provided on an outer peripheral portion of the cylinder, and the accumulator container is sandwiched between the nut and the protrusion.
